(19) United States
(12) Patent Application Publication
(10) Pub. No.: US 2005/0100136 A1
(43) Pub. Date: May 12, 2005

(54) Image displaying apparatus and program

(75) Inventor: Harumi Kawatsu, Tokyo (JP)

Correspondence Address: MUSERLIAN, LUCAS AND MERCANTI, LLP, 475 PARK AVENUE SOUTH, 15TH FLOOR, NEW YORK, NY, 10016, US

(73) Assignee: KONICA MINOLTA MEDICAL & GRAPHIC, INC.

(21) Appl. No.: 10/969,123

(22) Filed: Oct. 20, 2004

(30) Foreign Application Priority Data
Oct. 28, 2003 (JP) JP2003-367354

(51) Int. Cl. G01D 18/00

(52) U.S. Cl. 378/207; 702/81

(57) ABSTRACT

An image displaying apparatus including: a display section for displaying medical image and calibration image within a predetermined image displaying area; a storage section for storing information of the predetermined image displaying area; a display control section for conducting to display the calibration image for brightness measurement within the predetermined image displaying area stored in the storage section; and a calibration section for calibrating the display section based on the result of measuring the brightness of the calibration image displayed on the display section.

### FIELD OF THE INVENTION

The present invention relates to an image display apparatus for displaying an image on a display means, and a program used therefore.

### BACKGROUND OF THE INVENTION

In recent years, digitalization of a radiographic image and other medical images obtained by radiographing a patent has been put into practice in a medical institution. When interpreting a medical image, it is a common practice to use a soft copy with image data displayed on a display means such as a CRT (cathode ray tube) and LCD (liquid crystal-display), in addition to a hard copy where image data is outputted on a recording medium such as film.

In recent years, many hospitals are equipped with a plurality of display terminals for interpretation of radiogram. When the same image is outputted, the output characteristics are different according to each output destination, and therefore the reproducibility including the image density and contrast is different for each output destination. Such differences in the reproduced images are not preferable for diagnosis of a patient. For example, when an image of the chest of the same patient is interpreted by a plurality of terminals for interpretation of a radiogram, it is preferred that the reproducibility of an image be the same, independently of the terminal used.

To solve this problem, an image processing method has been developed to ensure that the same image has the same reproducibility of gradation between a film output apparatus another film output apparatus, between a film output apparatus and a display apparatus, or between a display apparatus and another display apparatus (see the Official Gazette of Japanese Patent Tokkaihei 9-261479). Another image processing method that has been developed is the one for ensuring that, when a CRT display means is used to display an image, an image of a desired brightness and gradation can be displayed at all times, even if the CRT brightness characteristics has deteriorated (for example, see the Official Gazette of Japanese Patent Tokkaihei 8-263031).

However, neither of the aforementioned methods refers to a technique for providing adequate calibration in the specific area for displaying the image data as a diagnostic image, out of the display areas in the display apparatus.

For example, the Official Gazette of Japanese Patent Tokkaihei 8-263031 disclosed a technique of measuring the brightness of a plurality of the test patterns displayed on a display means, and correcting a conversion table based on the result of measuring the brightness. However, in the display areas, the area for displaying the test pattern and performing calibration is independent of the area for displaying the image data as a diagnostic image. Thus, when creating a gradation correction table in the aforementioned specific area, the result of measurement in the area (i.e. an independent area) for calibration may not be adequately reflected. The Official Gazette of Japanese Patent Tokkaihei 8-263031 fails to refer to this point.

Incidentally, when a medical image is displayed on a display apparatus and is interpreted, a wide variety of image layouts are utilized. Examples include (1) an image layout wherein the display area of a thumbnail image as the reduced image of a medical image is arranged in parallel with the display image of an enlarged image; (2) an image layout wherein an image layout wherein the medical image display area is arranged in parallel with the display area for a report (text data)-of medical findings inputted by a radiograph interpreting doctor; (3) an image layout wherein the medical image display area is arranged in parallel with the display area for the result of detecting the candidates for an abnormality shadow by the CAD (Computer-Aided-Diagnosis) for automatically detecting the candidates for an abnormality shadow from a medical image; (4) an image layout wherein a plurality of the medical images radiographed by a CT (Computed Tomography) are displayed; and (5) an image layout wherein an medical image is displayed in the same size as that in reading the medical image. The type of the image layout to be adopted depends on each hospital, radiograph-interpreting doctor or body part to be radiographed.

In recent years, large-sized screens have been developed. The influence of the indoor illumination and surrounding light such as sunshine varies according to the image display position. This has required calibration to be performed in response to the position and display size, in the aforementioned prior art.

### SUMMARY OF THE INVENTION

In view of the prior art described above, it is an object of the present invention to provide an image display apparatus capable of ensuring adequate calibration, independently of the screen size or layout of a display means.

(1) The invention described in (1) provides an image display apparatus, equipped with a predetermined display area, comprising:
a display section for displaying image data in the aforementioned display area;
a storage means for storing the information of image display area preset as an image data display area, out of the aforementioned display area;
a display control section for displaying a calibration image for brightness measurement in the area for display the image stored in the image display area, when the aforementioned display means is calibrated; and
a calibration section for calibrating the aforementioned display section based on the result of measuring the brightness of the calibration image displayed on the aforementioned display means.

(2) An image display apparatus described in (1), wherein
the aforementioned storage section stores the information of a plurality of the set image display areas;
the image display apparatus comprises a selection section for selecting the image display area for displaying the calibration image out of a plurality of the aforementioned image display areas; and
the aforementioned display control section displays the calibration image in the selected image display area.

(3) An image display apparatus described in (1), wherein
the aforementioned storage section stores information based on the association between the user information and the information on the image display area conforming to this user;
the image display apparatus has an input section for inputting the user information; and
the aforementioned display control section displays the calibration image in the image display area corresponding to the aforementioned user information inputted.

(4) An image display apparatus described in (1), wherein
the image displayed on the image display area is a medical image of the specific site of a patient;
the storage section stores information based on the association between the information on the radiographed site in the medical image to be displayed and the information of the image display area corresponding to the radiographed site;
the image display apparatus comprises an acquisition section for acquiring the information on the radiographed site in the medical image to be displayed; and
the display control section for displaying the calibration image in the image display area corresponding to the radiographed site information.

(5) An image display apparatus described in one of (1) through (4), wherein
the aforementioned display control section allows a calibration image to be displayed in each image display area when there are a plurality of image display areas to be displayed in a predetermined display area; and
the calibration section applies calibration to each of the multiple image display areas, creates a gradation correction table conforming to the display characteristics of the display section based on the result of calibration, and converts the gradation of the image to be displayed, using the gradation correction table conforming to the image display area used for display, at the time of image display.

(6) A program for allowing a computer to perform the following functions, wherein the computer has a predetermined display area and a display section for displaying image data in this display area;
a function of permitting a storage section to store the information of the image display area preset as an area for displaying the image data, out of the aforementioned display areas;
a function of allowing the image section to display the calibration image for measuring the brightness, in the image display area stored in the storage section, at the time of calibration of the display section; and
a function of calibrating the display section, based on the result of measuring the brightness of the calibration image displayed by the display section.

According to the invention described in (1), a calibration image is displayed in a predetermined image display area. In addition to the display characteristics of the display section, this arrangement allows the calibration of various conditions to be performed, including the calibration of the position and size of the displayed image at the time of actual image interpretation. Thus, the optimum gradation image can be displayed, independently of the environmental conditions of the image interpretation.

According to the invention described in (2), a calibration image is displayed in the image display area selected by the user from multiple image display areas. This allows the calibration to be performed in conformity to a user interpreting the image.

According to the invention described in (3), information is stored based on the association between the user information and the information on the image display area conforming to this user, and calibration image is displayed in the image display area conforming to the user, at the time of calibration. This arrangement ensures calibration to be carried out conforming to the user interpreting the image.

According to the invention described in (4), information is stored based on the association between the information on the radiographed site and the information of the image display area corresponding to the radiographed site, and the calibration image is displayed in the image display area conforming to the radiographed site in the medical image to be displayed at the time of calibration. This arrangement ensures calibration to be carried out conforming to actual image interpretation requirements.

According to the invention described in (5), when there are multiple image display areas, brightness of each image display area is measured, a gradation correction table conforming to each image display area is created, and the gradation is converted according to the gradation correction table conforming to each image display area, at the time of image display. This arrangement allows the calibration of various conditions to be performed, including the calibration of the position and size of the displayed image.

### BRIEF DESCRIPTION OF THE DRAWINGS

FIG. 1 is a diagram representing the internal structure of an image display apparatus 10 as an embodiment of the present invention;

FIG. 2 is a diagram representing an example of the data layout of a layout table 161 for storing the information in the image display area set for each layout;

FIG. 3 is a flowchart showing a process of calibration image display as a first embodiment;

FIG. 4(a) is a diagram showing an example of calibration image display in layout 1, while FIG. 4(b) shows an example of other calibration image display;

FIG. 5(a) is a diagram showing an example of calibration image display in layout 2, while FIG. 5(b) shows an example of calibration image display in layout 3;

FIG. 6(a) is a diagram representing the case where a gradation conversion table 2 is applied to the medical image B as the current image, when there are two image display areas, one for a current image and the other for a past image, and FIG. 6(b) shows the case where a gradation conversion table 1 is applied to the medical image B as the past image;

FIG. 7 is a diagram representing an example of data layout in the user table 162;

FIG. 8 is a flowchart showing the process of calibration image display in the second embodiment;

FIG. 9 is a diagram representing an example of the data layout in a site table 163; and

FIG. 10 is a flowchart showing the process of calibration image display in the third embodiment.

### DETAILED DESCRIPTION OF PREFERRED EMBODIMENTS

### Embodiment 1

In the first embodiment, the following describes an example of displaying a calibration image in the image display area selected by a user, at the time of calibration.

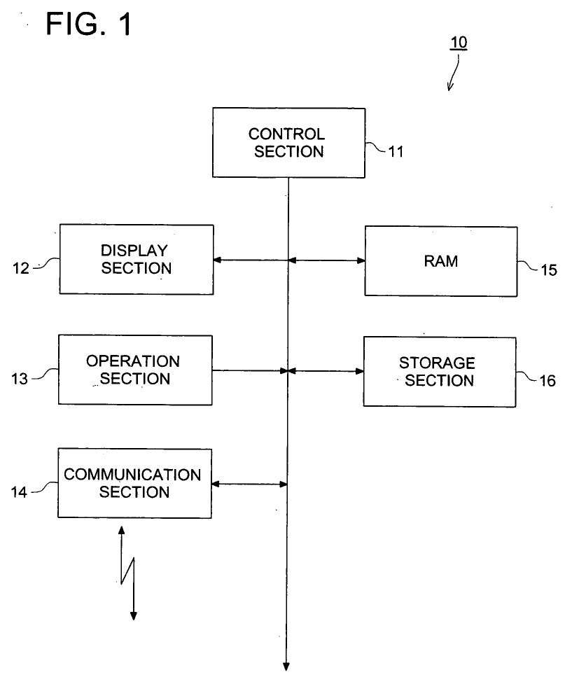

FIG. 1 represents the internal structure of an image display apparatus 10 as an embodiment.

As shown in FIG. 1, the image display apparatus 10 comprises a control section 11, display section 12, an operation section 13, a communication section 14, a RAM (Random Access Memory) 15 and a storage section 16.

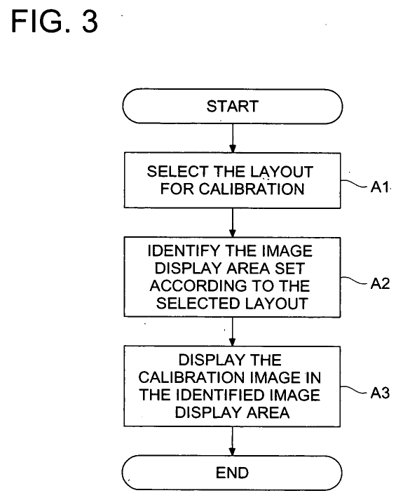

The control section 11 is composed of a CPU (Central Processor Unit) and others. The calibration image display processing programs and others related to the present invention (see FIG. 3), in addition to the system program stored in the storage section 16, are expanded on the RAM 15, thereby controlling processing operations in a comprehensive manner through collaboration with the aforementioned program.

In the process of calibration image display, the system identifies the image display area according to the layout selected by the user through the operation section,13, out of the multiple layouts, prepared in advance, which are the image layouts (hereinafter referred to as “layouts”) where the layout position and size of the image display area in the display area of the display section 12 are set. Thus, the display section 12 is controlled to display the calibration image in this image display area. To be more specific, the function of the display control section 12 is performed through collaboration between the calibration image display processing program and control section 11.

Further, the control section 11 implements the function of the calibration section. When the brightness of the displayed calibration image has been measured and the result of measurement has been inputted, a gradation conversion table is created based on the result of measuring the brightness. When the display of the medical image has been designated at the time of interpreting the image, the medical image to be displayed is subjected to gradation conversion according to the gradation conversion table created conforming to the image display area. The medical image subjected to gradation conversion is displayed in the image display area.

The display section 12 is equipped with a display device such as a CRT and LCD. It displays on the display device the medical image data, the report of medical findings, and the text data on the results of detecting the candidates for abnormal shadow by the CAD, according to the layout designated by the control section 11.

The operation section 13 is composed of a keyboard provided with numeric keys, letter keys and function keys, a mouse, a touch panel built integrally with the display section 12. The operation signal corresponding to the pressed key is outputted to the control section 11.

The communication section 14 forms a means for communication provided with a communication interface such as a network interface card and model, and is used to exchange data with an external device on the communication network. For example, it is connected to the medical image generation apparatus on the LAN (Local Area Network) to receive generated medical image data or to send the medical image data with information on the reports of medical findings attached thereto, to a server.

The RAM 15 constitutes a work area for temporarily storing various programs to be executed by the control section 11 and data related to these programs.

The storage section 16 is composed of a magnetic or optical recording medium or a semiconductor memory. It stores the calibration image display processing programs and the data processed by each program, in addition to system programs.

Further, the storage section 16 stores a layout table 161 for loading the information on the layout (hereinafter referred to as “layout information) where the layout position and size of the image display area in the display are preset.

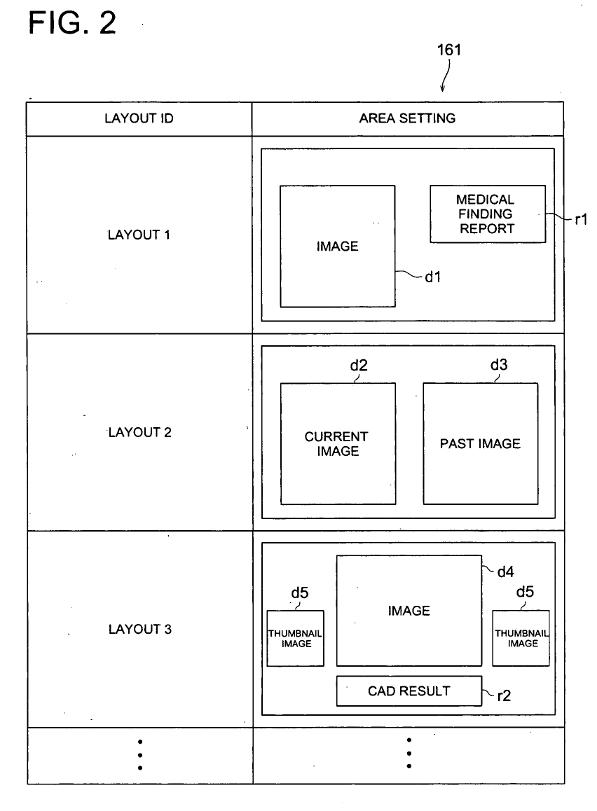

The layout table 161 stores the identification information (hereinafter referred to as “layout ID”; for example, the ID code of “layout 1”) for separate identification of each layout, as shown in FIG. 2, and the area setting information on the layout position and display size in the image display area set by this layout ID, and the display area for the medical finding report and thumbnail image. In this table, these pieces of information are stored in the form associated with each other.

In the layout 1, the screen is split into the right and left portions, as shown in FIG. 2. An image display area d1 is arranged on the left, and a medical finding report display area r1 is arranged on the right top. The layout 2 is used to display the medical image of the same patient. The screen is split into the right and left portions. A current image display area d2 is arranged on the left and a past image display area d3 is arranged on the right. Further, the layout 3 shows the result of detecting the candidate for abnormal shadow (hereinafter referred to as “CAD result”). A medical image display area d4 is located at the center of the screen, a thumbnail image display area d5 is placed on both side thereof, and a text data display area r2 showing the CAD result is set below the medical image.

The storage section 16 stores the image data of the image for measuring the brightness, used for calibration (hereinafter referred to as “calibration image”).

The following describes the operation in the first embodiment: FIG. 3 is a flowchart showing a process of calibration image display carried out by the image display apparatus 10.

In the process of calibration image display shown in FIG. 3, the control section 11 scans each piece of layout information set on the layout table 161, and the information is displayed on the display section 12 so that it can be selected as the layout for calibration. The user employs the operation section 13 to select the layout to be calibrated, out of the displayed layouts.

When the layout for calibration has been selected by the user through the operation section 13 (Step A1), the control section 11 scans the information on the image display area set according to the selected layout, from the layout table 161. Then the image display area set according to the selected layout is identified (Step A2).

The calibration image is displayed in the identified image display area under control of the control section 11 (Step A3).

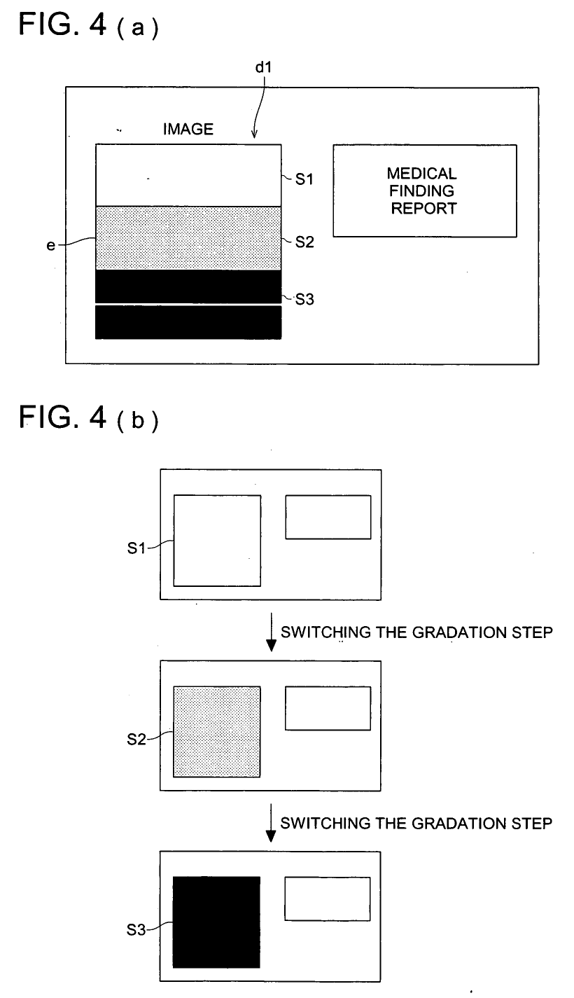

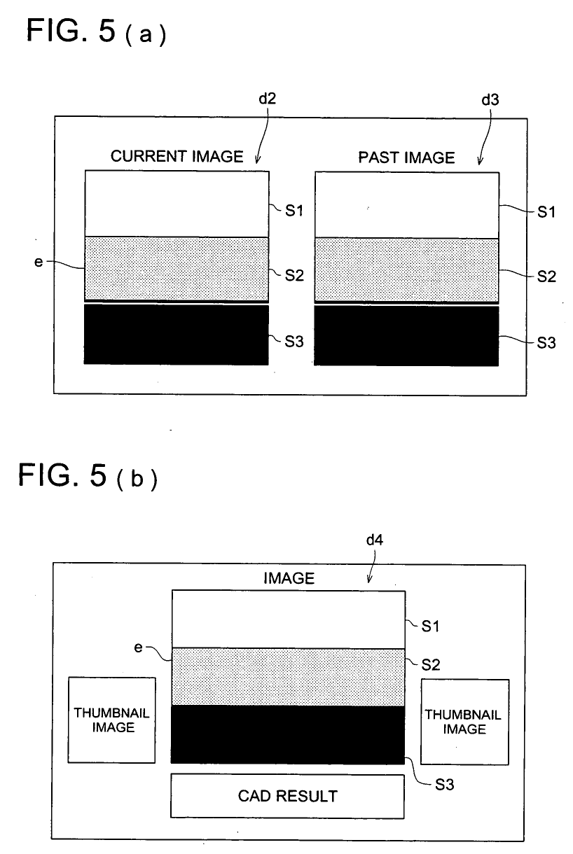

FIGS. 4 and 5 show an example of calibration image display.

For example, when the layout 1 has been selected, a calibration image is displayed in the image display area d1 of the layout 1 shown in FIG. 2, and the layout screen shown in FIG. 4(a) is displayed in the display section 12. As shown in FIG. 4(a), the calibration image “e” is a gray scale is a gray scale having three-gradation step s1 through step s3.

One example is given in the calibration image “e” given in FIG. 4(a), without the present invention being restricted thereto. For example, the number of the gradation steps can be increased to improve the correction accuracy. Further, the display method of the present invention is not restricted to the one given above. As shown in FIG. 4(b), the gradation step s1 of low density is displayed in the entire image display area. After the brightness in the gradation step s1 has been measured, the gradation step s2 is displayed on the entire image display area in response to the instruction. In this manner, the gradation step s1 through step s3 are sequentially switched for display over the entire image display area. Such an arrangement can also be configured.

As shown in FIG. 5(a), when the layout 2 has been selected, the calibration image “e” is displayed in the image display areas d2 and d3 of the layout given in FIG. 2. In the layout 2, image display areas d2 and d3 for two images—the current image and past image—are set, and therefore the calibration image is displayed in each of these two image display areas d2 and d3. Thus, separate measurement of the brightness is carried out.

As shown in FIG. 5(b), when the layout 3 has been selected, calibration image “e” is displayed in the medical image display area d4 of the layout 3 given in FIG. 2.

When the calibration image has been displayed in the image display area set according to the layout selected in the aforementioned manner, the present processing terminates.

After the calibration image has been displayed, the brightness of the displayed calibration image is measured and the control section 11 creates the gradation correction table according to the result of measuring the brightness. To put it more specifically, a display characteristic curve is obtained by plotting the brightness values measured in response to each gradation step of the calibration image. A curve having inverse characteristics with respect to the target gradation curve is obtained from this display characteristic curve. The inverse characteristic curve is tabulated to form a gradation correction table. To display the medical image, the created gradation correction table is used to apply gradation conversion of the medical image. The gradation-converted medical image is displayed in the image display area of the aforementioned selected layout.

In the case of layout 2 shown in FIG. 5(a), a gradation conversion table is created for each of the two image display areas. At the time of gradation conversion, each medical image is subjected to gradation conversion according to the gradation conversion table conforming to the image display area where the medical image is displayed.

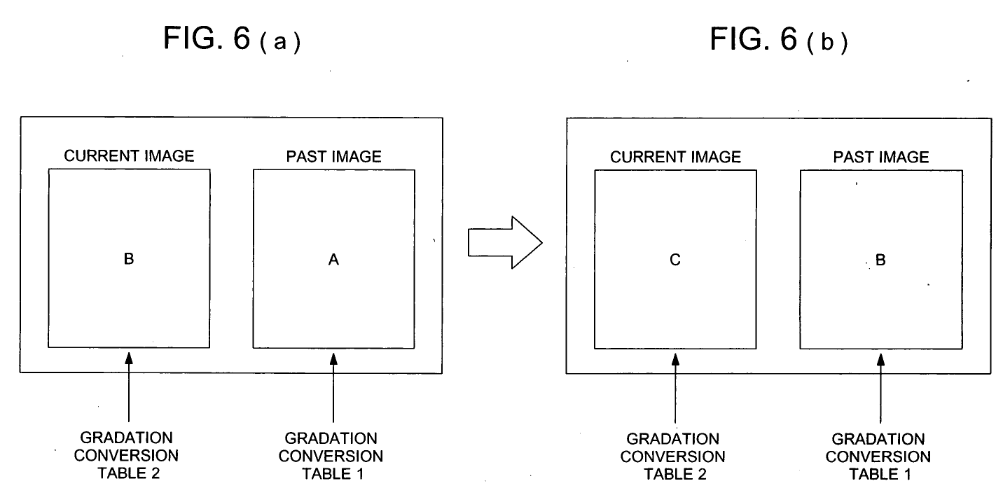

For example, as shown in FIG. 6(a), a gradation conversion table 1 is created in the current image display area, and a gradation conversion table 2 is created in the past image display area. When the medical image A as the past image and the medical image B as the current image are displayed, the gradation conversion table 1 is used for the medical image A, and the gradation conversion table 2 is employed for the medical image B. However, when the medical image B has come to be displayed as the past image with the lapse of time, the gradation conversion table 1 is applied to the medical image B, as shown in FIG. 6(b), whereby gradation conversion is performed.

As described above, in the first embodiment, the calibration image is displayed in the image display area set according to the selected layout. Thus, in addition to the display characteristics of the display section 12, there is a function of performing calibration including the calibration of the position and size of the medical image to be displayed, at the time of actual image interpretation. This arrangement allows the medical image of the optimum gradation to be displayed, independently of the environmental conditions for image interpretation

Further, since calibration is carried out only in the image display area, efficient calibration can be ensured.

### Embodiment 2

With reference to the second embodiment, the following describes the case where the user information and the information of the image display area applied to that user are stored and the information in the image display area conforming to the inputted user information is scanned at the time of calibration; then the calibration image is displayed in this image display area.

In the first place, the configuration will be described. The image display apparatus of the second embodiment has the same configuration as that of the image display apparatus 10 of the first embodiment. The same portions as the first embodiment will be assigned with the same reference numerals and the illustration will be omitted. Only the portions of different functions will be described, to avoid duplication.

In the second embodiment, when the user information has been inputted through the operation section 13, the control section 11 acquires the layout information conforming to this user information, from the user table (to be described later) stored in the storage section 16. It acquires the information of the image display apparatus set according to the acquired layout, from the layout table 161, and identifies the image display area. By controlling the display section 12, the control section 11 causes the calibration image to be displayed in this image display apparatus.

Further, when the brightness of the displayed calibration image has been measured and the result of the measurement has been inputted, the control section 11 creates a gradation conversion table, based on the result of measuring the brightness. When the medical image display is designated at the time of image interpretation, the medical image to be displayed is subjected to gradation conversion according to the gradation conversion table created in response to the image display area, and the medical image subjected to gradation conversion is displayed in the image display area by the control section 11.

The storage section 16 has a user table 162 with a layout set as applicable to each user, in addition to the layout table 161 (see FIG. 2). The layout table 161 is the same as the one described with reference to the first embodiment, and will not be described here.

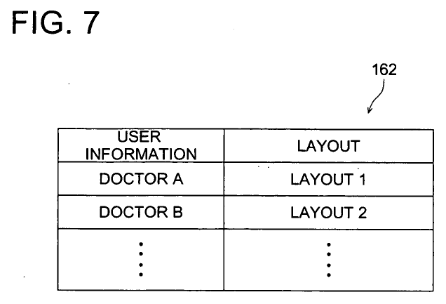

The user table 162 stores a layout ID (e.g. “layout 1”), as the information of the layout to be used by the user at the time of image interpretation, in association with the user information such as a doctor's name (e.g. “Doctor A”), as shown in FIG. 7.

The following describes the operation of the second embodiment:

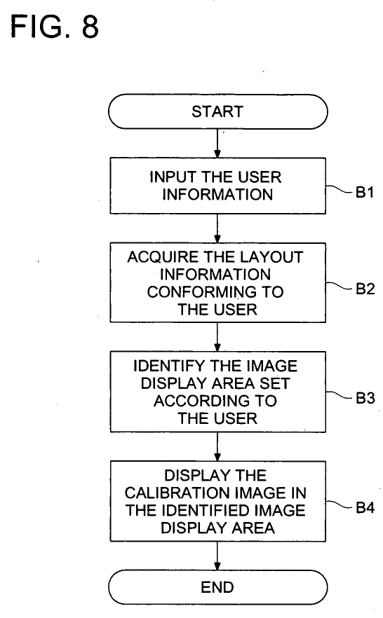

FIG. 8 is a flowchart showing the process of calibration image display in the second embodiment.

In the process of calibration image displayed in FIG. 8, the input screen for inputting the user information is displayed on the display section 12 and the user information is inputted (Step B1). When the user information has been inputted through the operation section 13, the information of the layout ID corresponding to this user information is acquired from the user table 162 (Step B2). It is also possible to arrange such a configuration that the layout ID information is acquired, using the user information to be inputted for user authentication when logging in to the image display apparatus 10, instead of inputting the user information for calibration.

When the layout ID information has been obtained, the information on the image display area set according to the layout of this layout ID is read from the layout table 161, and the position of the image display area and the image size are identified (Step B3).

The calibration image is displayed in the identified image display area under the display control of the control section 11 (Step B4). The example of the display of the calibration image in the image display area set according to each layout is the same as the one referred to in the description of the first embodiment with reference to FIGS. 4 and 5, so the detailed description will be omitted.

When the calibration image has been displayed, the present processing terminates.

Subsequent to display of the calibration image, the brightness of the displayed calibration image is measured, and the control section 11 creates the gradation correction table according to the result of measuring the brightness. When the medical image is displayed, the medical image is subjected to gradation conversion according to the created gradation correction table. The medical image subjected to this gradation conversion is displayed in the image display area in the layout selected in the aforementioned step.

In the case of the layout 2 shown in FIG. 5(a), a gradation correction table is created for each of the two image display areas at the time of calibration. The gradation conversion table corresponding to each image display area is used at the time of image display, in the same manner as referred to in the description of the first embodiment.

As described above, according to the second embodiment, the layout information applied to the user is stored in advance and the calibration image is displayed in the image display area set according to the layout conforming to the user information inputted at the time of calibration. This arrangement enables calibration including the calibration of the position and size of the medical image to be displayed at the time of actual image interpretation, in addition to the display characteristics of the display section 12. It allows the medical image of the optimum gradation to be displayed, independently of the environmental conditions for image interpretation.

Since calibration is carried out only in the image display area, calibration efficiency has been improved.

### Embodiment 3

In the third embodiment, the information of the image display area applicable to each of the site of the image to be displayed is stored, and the information of the image display area conforming to the site information obtained at the time of calibration is read out. Then the calibration image is displayed in this image display area. An example of this processing will be described below:

In the first place, the configuration will be described. The image display apparatus in the third embodiment has the same configuration as that of the image display apparatus 10 referred to in the description of the first embodiment. Accordingly, the same portions as the first embodiment will be assigned with the same reference numerals and the illustration will be omitted. Only the portions of different functions will be described, to avoid duplication.

In the third embodiment, when the radiographed site information has been obtained from the supplementary information of the medical image, the control section 11 acquires the layout information conforming to this radiographed site information from the site table (to be described later) stored in the storage section 16. The image display area information set according to the obtained layout is acquired from the layout table 161 and the image display area is identified. The control section 11 controls the display section 12 in such a way that the calibration image will be displayed in this image display area.

Further, when the brightness of the displayed calibration image has been measured and the result of measurement has been inputted, the control section 11 creates a gradation conversion table according to the result of brightness measurement. When the display of the medical image has been designated at the time of image interpretation, the medical image to be displayed is subjected to gradation conversion according to the gradation conversion table created conforming to the image display area, and the medical image having been subjected to this gradation conversion is displayed in that image display area.

The storage section 16 contains a site table 163 wherein a layout applied to the medical image of the radiographed site is set for each of the radiographed sites, in addition to the layout table 161 (see FIG. 2). The layout table 161 is the same as the one referred to in the description of the first embodiment and will not be described here.

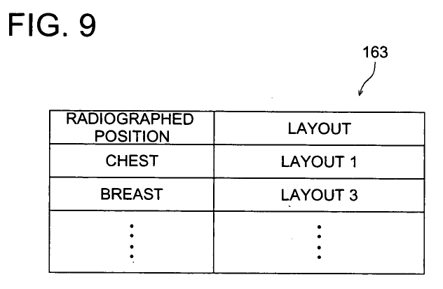

As shown in FIG. 9, the site table 163 contains the site name (e.g. “chest” and “breast”) and the layout information applied for display of the medical image of that site (e.g. the layout ID of the “layout 1”), in the form associated with each other.

The following describes the operation of the third embodiment:

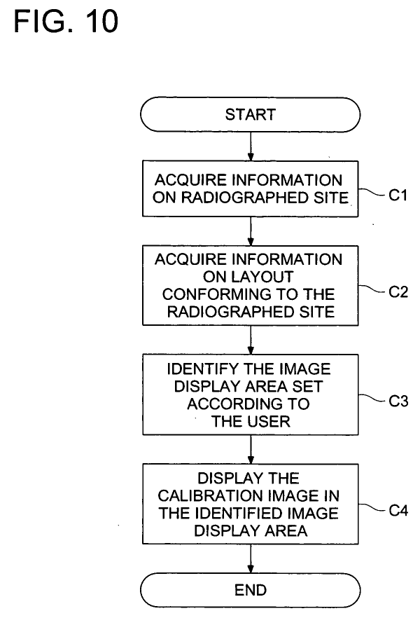

FIG. 10 is a flowchart showing the process of calibration image display in the third embodiment.

In the process of calibration image display shown in FIG. 10, the information of the radiographed site of the medical image to be displayed is acquired in the first place (Step C1). The information on the radiographed site may be acquired by scanning the information on the radiographed site contained in the supplementary information attached to the medical image, for example. It is also possible to acquire the information on the radiographed site inputted by the user through the operation section 13. Alternatively, it is also possible to acquire the information on the radiographed information by making reference to the HIS (Hospital Information System) for managing the in-hospital information through the communication section 14 or the RIS (Radiography Information System) for managing the information of the department of radiology.

When the information on the radiographed site has been obtained, the layout information conforming to that site is acquired from the user table 162 (Step C2). Then the information of the image display area set according to the layout conforming to the acquired layout information is read from the layout table 161, and the position of the image display area and image size are identified (Step C3).

Then a calibration image is displayed in the image display area identified by display control of the control section 11 (Step C4). The example of the calibration image displayed in the image display area set according to each layout is the same as the one referred to in the description of the first embodiment with reference to FIGS. 4 and 5, and will not be described here.

The present processing terminates when the calibration image has appeared on the screen.

After display of the calibration image, the brightness of the displayed calibration image is measured and the control section 11 creates a gradation correction table conforming to the result of measuring the brightness. When the medical image is displayed, the medical image is subjected to gradation conversion according to the created gradation correction table and the medical image subjected to gradation conversion is displayed in the image display area according to the layout selected in the aforementioned procedure.

In the case of layout 2 shown in FIG. 5(a), a gradation correction table is created for each of the two image display areas at the time of calibration. A gradation conversion table is used in conformity to each image display area when the image is displayed. This procedure is the same as the one referred to in the description of the first embodiment.

As described above, according to the third embodiment, the information on the layout applied to each radiographed site is stored in advance and the calibration image is display in the image display area set according to the layout conforming to the radiographed site information obtained at the time of calibration. This arrangement enables calibration including the calibration of the position and size of the medical image to be displayed at the time of actual image interpretation, in addition to the display characteristics of the display section 12. It allows the medical image of the optimum gradation to be displayed, independently of the environmental conditions for image interpretation.

Further, since calculation is carried out only in the image display area, calibration efficiency is improved.

1. An image displaying apparatus comprising:
a display section for displaying medical image and calibration image within a predetermined image displaying area;
a storage section for storing information of the predetermined image displaying area;
a display control section for conducting to display the calibration image for brightness measurement within the predetermined image displaying area stored in the storage section; and
a calibration section for calibrating the display section based on the result of measuring the brightness of the calibration image displayed on the display section.

2. The image displaying apparatus of claim 1, wherein
the storage section stores the information of a plural sets of the image displaying areas, and
the image display apparatus further comprising:
a selecting section for selecting a image displaying area as the predetermined image displaying area for displaying the calibration image from the plural sets of the image displaying areas; and
wherein the display control section conducts to display the calibration image within the selected image displaying area.

3. The image displaying apparatus of claim 1, wherein
the storage section stores user information and image displaying area information corresponding to the user-information, and
the image display apparatus further comprising:
an input section for inputting the user information; and
wherein the display control section conducts to display the calibration image within the image display area corresponding to the user information inputted.

4. The image displaying apparatus of claim 1, further comprising:
an acquisition section for acquiring the part information of a part of an object to be displayed as the medical image, and
wherein the storage section stores the part information and the image displaying information corresponding to the part of an object to be displayed, and
wherein the display control section conducts to display the calibration image within the image displaying area corresponding to the part information.

5. The image displaying apparatus of claim 1, wherein
the display control section allows a calibration image to be displayed in each image displaying area when there are a plural sets of the image displaying areas to be displayed; and
wherein the calibration section applies calibration to each of the multiple image displaying areas, creates a gradation correction table conforming to the display characteristics of the display section based on the result of calibration, and converts the gradation of the medical image to be displayed, using the gradation correction table corresponding to the image displaying area used for display, at the time of the medical image displaying.

6. A computer program to control a computer to function as imager, wherein the imager comprising:
a displaying function for displaying medical image and calibration image within a predetermined image displaying are on a display section;
a storage function for storing information of the predetermined image displaying area in a storage section;
a display function for conducting to display the calibration image for brightness measurement within the predetermined image displaying area stored in the storage section; and
a calibration function for calibrating the display section based on the result of measuring the brightness of the calibration image displayed on the display section.
